(19) United States
(12) Patent Application Publication
(10) Pub. No.: US 2026/0288946 A1
(43) Pub. Date: Sep. 24, 2026

(54) OUT-OF-BAND DATA SECURITY MANAGEMENT

(71) Applicant: Dell Products L.P., Round Rock, TX (US)

(72) Inventors: PHANINDRA BHARGAV TALASILA, Georgetown, TX (US); IBRAHIM SAYYED, Georgetown, TX (US); XIAOMEI ZHU MILLER, Round Rock, TX (US); ADOLFO SANDOR MONTERO, Pflugerville, TX (US)

(21) Appl. No.: 19/085,700

(22) Filed: Mar. 20, 2025

(51) Int. Cl. G06F 21/55; G06F 21/88

(52) U.S. Cl. CPC G06F 21/554; G06F 21/88; G06F 2221/034

(57) ABSTRACT

Methods and systems for managing operation of a data processing system are disclosed. To do so, a security management event may be identified by an out-of-band component of the data processing system, the identification indicating that data stored on the data processing system may be at risk of access by an unauthorized entity. Based on the identification, a security management process to prevent accessing of at least a portion of the data by the unauthorized entity may be initiated by a management controller using a sideband channel between the management controller and a storage device of hardware resources of the data processing system in which the at least the portion of the data is stored.

### FIELD

Embodiments disclosed herein relate generally to managing operation of data processing systems. More particularly, embodiments disclosed herein relate to managing data and/or file security across a distributed system for data processing systems potentially subjected to unauthorized access.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2B show interaction diagrams in accordance with an embodiment.

FIG. 3 shows a flow diagram illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary de vices, such as in a network topology.

In general, embodiments disclosed herein relate to methods and systems for managing operation of a data processing system within a distributed environment that may include any number of data processing systems. The (any number of) data processing systems may provide computer-implemented services to any type and/or number of other devices and/or users of the data processing systems. The computer-implemented services may include any quantity and type of such services.

To provide the computer-implemented services, the data processing systems may each include any number of hardware components whose respective operations may facilitate various functionalities of the data processing systems. For example, any one of the data processing systems may include any number of storage devices for storing data and allowing future access to this stored data by processes performed by the any one of the data processing systems.

For example, an authorized user of one of the data processing systems may store a number of professional and/or personal documents and media files on a non-volatile memory express (NVMe) storage device while this NVMe storage device is operably connected to the (one) data processing system. The user may then continue to access these professional and/or personal documents and media files for any number of reasons not to be limited by embodiments discussed herein. This continued access may be made possible due to the allocation of physical storage space of the NVMe storage device for the professional and/or personal documents and media files to be recorded/committed to.

However, this NVMe storage device may be at risk of, and/or subjected to, an attempt to access its contents by some unauthorized and/or otherwise unknown entity (e.g., there may be a risk of unauthorized access to the data).

Such an attempt at unauthorized access may be an attempt to exploit the user's professional and/or personal data by extracting and/or otherwise reading said data to, for example, glean information regarding the authorized user. Should the unauthorized access occur, not only may the user's data now be at the mercy of an unknown entity's exploitation, but the distributed system in which the data processing system is a part may be negatively impacted (e.g., by unauthorized disclosure of the system's security configurations and protocols, manipulation and/or sabotage of necessary portions of the data, etc.), thereby increasing a likelihood of negatively impacting the computer implemented services that any portion of the distributed system may provide.

Therefore, a management system, a management controller of the data processing system and/or a controller of the NVMe storage device may collaborate via out-of-band communication channels of the data processing system to detect security events that indicate displacement of the data processing system from the authorized user, thereby indicating that the data processing system may no longer be in the authorized user's possession (e.g., and may therefore be at risk of unauthorized access).

Such collaboration may be followed by performance of a security management process that continues to utilize advantages provided by the out-of-band communication channels. Such advantages may include, for example, the out-of-band channels being isolated from (and therefore saved from) interference via in-band communication channels that may be at the mercy of, and therefore be vulnerable to, manipulation by the unknown entity.

The security management process may therefore include any number of processes to prevent the unauthorized access of the data while an unknown/unauthorized entity is inferred to have physical access to the data processing system. For example, such processes may include facilitation of at least partial encryption of the NVMe storage device to prevent the unknown entity from accessing highly sensitive data from the data processing system.

Additionally, the collaborative detection, as well as the security management process, may also be performed to achieve a reverse goal in an event that the authorized user is reunited with the data processing system. For example, once the NVMe storage device is partially encrypted to make the highly sensitive data unusable, a new security event indicative of the data processing system's return to the authorized user may be detected. Performance of another security management process may follow the new detection, this time the NVMe storage device being gradually decrypted as the authorized user's reestablished possession of the data processing system is verified.

Should security events indicative of such displacements or returns (from or to the authorized user) be detected early enough after such security events occur, the security management processes may include successfully mitigating negative impacts on operation of the NVMe storage device, operation of the data processing system, operation of the distributed system, and/or the (providing of the) computer implemented services.

Thus, embodiments disclosed herein may provide a method for managing, by one or more out-of-band components, operation of a data processing system by utilizing sideband (e.g., out-of-band) communication channels to detect (e.g., infer) a likely high-risk security event that poses a threat to data stored on an NVMe storage device of the data processing system. This detection (e.g., inferred to be a high-risk security event) may then, for example, be used to manage operation of the NVMe storage device specifically. By doing so, a likelihood of data stored on the NVMe storage device being used in an unauthorized manner (such as without the authorized user's knowledge and/or with disregard for the authorized user's privacy and/or autonomy) may be decreased. Additionally, the sooner performances of such processes are completed based on security event detections, the more data/files of data stored on NVMe storage device that may remain private/secure. In contrast, the longer it takes to perform and complete such processes, the more data/files of data that may be lost/exploited by unknown threats.

In an embodiment, a method for managing operation of a data processing system is provided.

The method may include identifying, by an out-of-band component of the data processing system, an occurrence of a security management event for the data processing system, the security management event indicating that data stored on the data processing system is at risk of undesired access by an unauthorized entity; and based on the identifying of the occurrence: initiating, by a management controller and using a sideband channel between the management controller and a storage device of hardware resources of the data processing system in which at least a portion of the data is stored, a security management process to prevent accessing of the at least the portion of the data while the unauthorized entity is inferred to have physical access to the data processing system.

The out-of-band component may be one selected from a group consisting of the management controller and a controller of the storage device.

Identifying the occurrence of the security management event may include: obtaining at least one indicator regarding whether the unauthorized entity has physical access to the data processing system; and in an instance of the obtaining where the at least one indicator indicates that the unauthorized entity has the physical access to the data processing system: obtaining, using the at least one indicator, a confidence level in a conclusion that the unauthorized entity has physical access to the data processing system; and in an instance of the obtaining where the confidence level exceeds a threshold level: making the conclusion that the unauthorized entity has physical access to the data processing system and that the occurrence of the security management event has occurred.

Initiating the security management process may include identifying, based on the confidence level and a security policy, at least one security action; and performing the at least one security action to prevent the accessing of the at least the portion of the data while the unauthorized entity is inferred to have physical access to the data processing system.

Policy may scale the at least the portion of the data based on the confidence level so that a higher confidence level results in a larger size of the at least the portion of the data.

The at least one indicator may include: a user reported theft status of the data processing system.

The at least one indicator may further include: information regarding an ambient environment to the data processing system.

Obtaining the at least one indicator may include: initiating generation, by a management controller of the data processing system, of an image depicting a portion of the ambient environment.

The at least one indicator may further include: location information for the data processing system.

The user reported theft status, the information regarding the ambient environment, and the location information may be used to obtain the confidence level using a scoring system, the scoring system quantifying the confidence level.

The management controller may operate independently from and may be distinct from the hardware resources.

The management controller may be on a separate power domain from the hardware resources so that the management controller is operable while the hardware resources are inoperable.

In an embodiment, a non-transitory media is provided. The non-transitory media may include instructions that when executed by a processor cause the computer-implemented method to be performed.

In an embodiment, a system is provided. The system may include the non-transitory media and a processor and may perform the computer-implemented method when the computer instructions are executed by the processor.

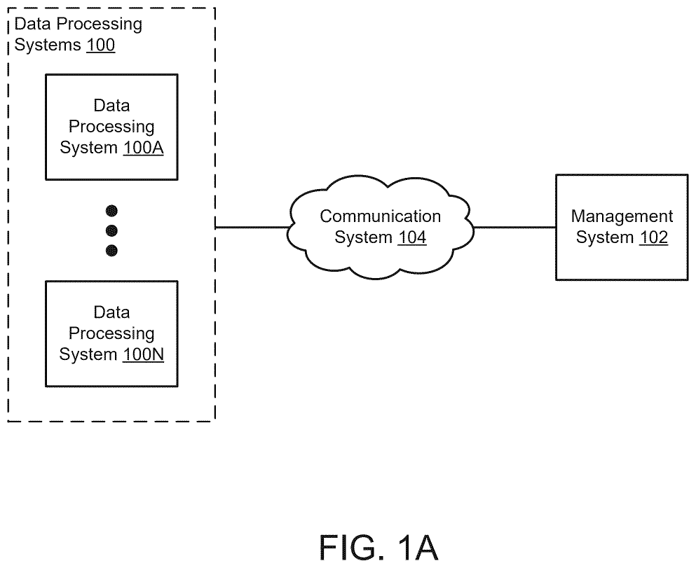

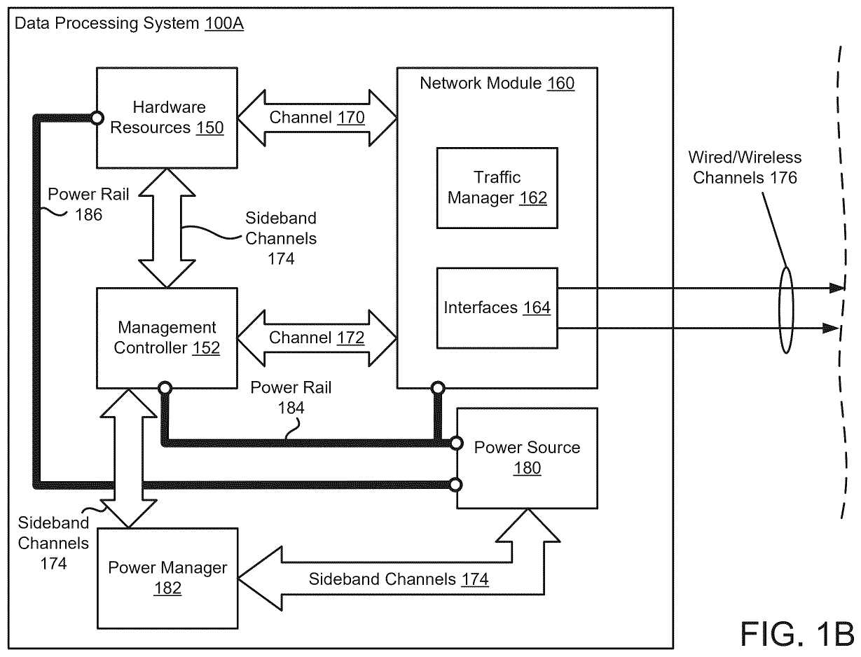

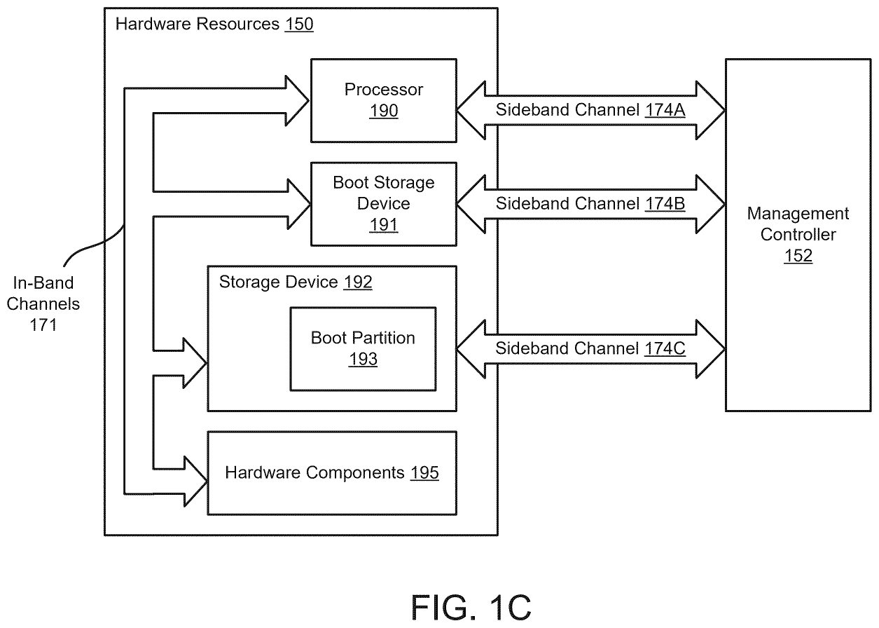

Turning to FIG. 1A, a block diagram illustrating a system in accordance with an embodiment is shown. The system shown in FIG. 1A may provide for management of data processing systems that may provide, at least in part, computer-implemented services (e.g., to a user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time.

For additional details regarding data processing systems 100, refer to FIG. 1B discussed further below.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. To provide the computer-implemented services, a data processing system may perform a booting process to initialize operation of the hardware resources. To do so, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

By performing the booting process, the hardware resources of the data processing system may be operably connected to each other (e.g., via in-band communication channels) and an operating system may be loaded to provide management functionalities.

Additionally, this operating system (OS) may utilize a file storage system whose storage may be physically allocated to, for example, cells on a non-volatile memory express (NVMe) storage device. By allocating such files of digital data to these cells, the files may be respectively stored at physical addresses on the NVMe storage device that may each be respectively associated with a digital (e.g., logical) address. For example, various directories/indexes may include associations between the digital and physical addresses respectively with one another. Therefore, (hardware and/or software) components that may depend on information stored in any one file from the files may request said file from the OS, the OS using the associations from the directories/indexes to read (e.g., obtain) the one file from storage.

Such files may be assumed to belong to a user (an authorized user) of the data processing system. For example, such files may include professional and/or personal information/data that may be privy to the user. Therefore, it may be further assumed that the user may initiate performance of various processes involving management of said files. Such interaction from the user to initiate such processes may be facilitated by software components such as a service client (e.g., a client adapted to display popup windows containing information for the user and that may take input from the user via any number of interactive elements to determine how operation of the data processing system may continue).

To facilitate operation of the data processing system, the OS and/or the service client may therefore be programs that run post-boot. For example, running programs such as the OS and the service client may be hosted by a processor (e.g., the central processing unit (CPU)) of the data processing system, and may utilize the in-band communication channels to facilitate operation of the data processing system. For example, this processor of the data processing system may perform (e.g., during boot) functionalities for a booting process that include taking inventory of any and all operably connected devices (e.g., via the in-band communication channels).

However, assume that, for example, the data processing system has been displaced from the authorized user due to, for example, being stolen by an unknown entity. This unknown entity may therefore attempt to access the data stored on the data processing system to utilize the data processing system as their own, glean information about the authorized user, and/or perform any number of other processes for any myriad of reasons not to be limited by embodiments discussed herein.

For example, if under an unknown entity's control (e.g., the unknown entity interacting with the data processing system via the service client hosted by the processor and running alongside, for example, the OS), any number of security features and/or configurations of the data processing system may be bypassed, deprecated, etc. Consequently, communications that may be intercepted and/or otherwise perverted by the unknown entity via in-band channels during management of connected devices may result in at least a portion of the hardware resource's inoperability and/or may otherwise negatively impact provisioning of the computer implemented services as expected and/or desired by, for example, the authorized user.

Consequently, such an unknown entity may facilitate and/or otherwise initiate performance of processes that the authorized user is unlikely to facilitate, such performances being associated with “signatures” (e.g., file-level and/or system-level patterns of activity) of a certain type that result from such performances. Additionally, along with such “signatures,” the data processing system may include telemetry data indicative of a new environment and/or a new user than what is known to be associated with the authorized user.

In general, embodiments disclosed herein relate to systems, devices, and methods for managing operation of a data processing system. To modify the operation of the data processing system in an event of the data processing system's displacement from an authorized user of the data processing system (e.g., due to theft) and/or an unauthorized attempt to access data from the data processing system, the data processing system may host a management controller that may operate independently from the hardware resources and may be distinct from, and adapted to manage, the hardware resources. For example, the management controller may operate during the booting process regardless of an outcome of the booting process performed by booting components (e.g., the boot storage device and/or the processor) of the hardware resources.

Similarly, the management controller may be capable of communication with any number of devices via out-of-band communication channels during the management of connected devices, thereby avoiding interference from, for example, an unauthorized user in possession of the data processing system while the management controller facilitates its own operation.

Therefore, to further manage the operation of the data processing system, the management controller may collaborate with a controller of the storage device to detect (high-risk) security events via out-of-band communication channels of the data processing system.

Such collaboration may be followed by performance of a security management process that continues to utilize advantages provided by the out-of-band communication channels. Such advantages may include, for example, the out-of-band channels being isolated from (and therefore saved from) interference via in-band communication channels that may be at the mercy of, and therefore be vulnerable to, manipulation by the unknown entity.

The security management process may include, for example, facilitation of at least partial encryption of the NVMe storage device to prevent the unknown entity from understanding and/or using highly sensitive data from the data processing system. Additionally, the collaborative detection, as well as the security management process, may also be performed to achieve the reverse. For example, once the NVMe storage device is partially encrypted to make the highly sensitive data unusable, a new security event indicative of the data processing system's return to the authorized user may be detected. Performance of another security management process may follow the new detection, this time the NVMe storage device being gradually decrypted as the authorized user's reestablished possession of the data processing system is verified.

Should security events indicative of such displacements or returns (from or to the authorized user) be detected early enough after such security events occur, the security management processes may include successfully mitigating negative impacts on operation of the NVMe storage device, operation of the data processing system, operation of the distributed system, and/or the (providing of the) computer implemented services.

Thus, embodiments disclosed herein may provide a method for managing, by one or more out-of-band components, operation of a data processing system by utilizing sideband (e.g., out-of-band) communication channels to detect (e.g., infer) a likely high-risk security event that poses a threat to data stored on an NVMe storage device of the data processing system. This detection (e.g., inferred to be a high-risk security event) may then, for example, be used to manage operation of the NVMe storage device specifically. By doing so, a likelihood of data stored on the NVMe storage device being used in an unauthorized manner (such as without the user's knowledge and/or with disregard for the user's privacy and/or autonomy) may be decreased. Additionally, the sooner performances of such processes are completed based on security event detections, the more data/files of data stored on NVMe storage device that may remain private/secure. In contrast, the longer it takes to perform and complete such processes, the more data/files of data that may be lost/exploited by unknown threats.

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., a management controller, network modules, etc.), and functionality that may allow the out-of-band components to communicate with management system 102 via an out-of-band communication channel.

While providing the computer-implemented services, a data processing system (e.g., 100A) of data processing systems 100 may communicate with and/or obtain information from management system 102. For example, data processing system 100A may communicate to management system 102 that a security event has been detected that may negatively impact operation of data processing system 100A. Management system 102 may, for example, be adapted to manage each of data processing systems 100 while performing other administrative duties and/or troubleshooting any occurrence of challenges for the distributed system.

Such a detection of a security event as mentioned above may be indicative of the data processing system's displacement from an authorized user to which the data processing system is associated (e.g., the authorized user having registered the data processing system prior to the displacement. Such displacement may indicate a high-risk of data processing system 100A's security being breached, and therefore, similar risk to the entire distributed system may have an increased likelihood of occurring. Thus, management system 102 may isolate data processing system 100A in such a manner as to quarantine data processing system 100A from the rest of data processing systems 100. By doing so, data processing system 100A may be triaged, without compromising any of the rest of data processing systems 100, based on user activity, current environment information, and/or other types of information not to be limited by embodiments discussed herein.

Any of data processing systems 100 may thereby obtain updated firmware for implementing an out-of-band detection process, management requests to modify operation of the hardware resources (e.g., installing new applications, encryption/decryption of data, etc.), and/or any other information. Data processing system 100A may subsequently perform actions based on the information obtained from management system 102 to update operation of data processing system 100A, cutoff potential access to data stored on the data processing system, and/or complicate any attempted utilization of such data. In doing so, the other data processing systems within the distributed system may be prevented from the unknown entity negatively impacting their operation.

Management system 102 may, as discussed above, provide remote management services. Management system 102 may include, for example, a second data processing system operated by an owner of data processing systems 100 (e.g., the authorized user). To provide the remote management services, management system 102 may interact with data processing systems 100 to obtain and/or provide information (e.g., data) relevant to operation of data processing systems 100.

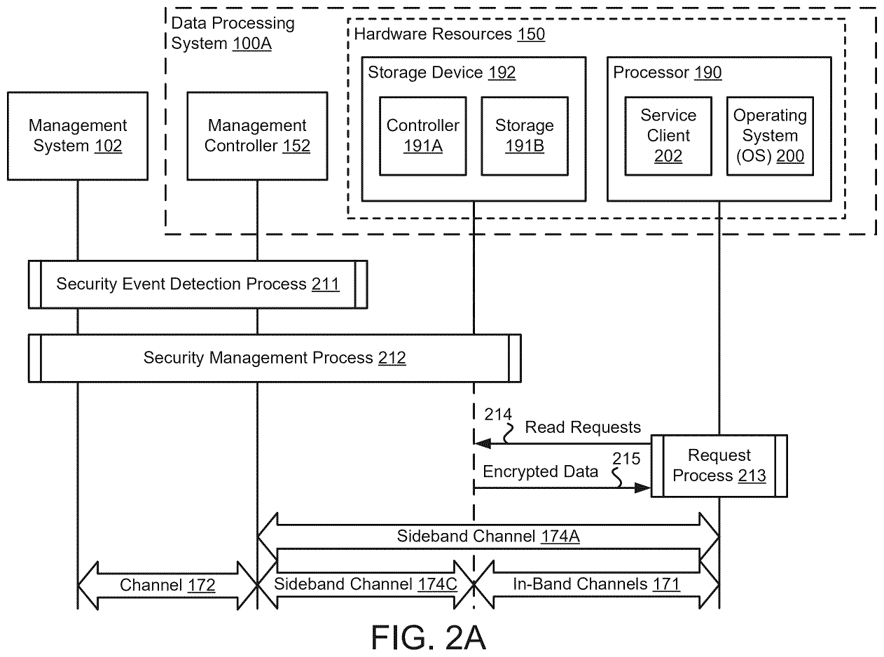

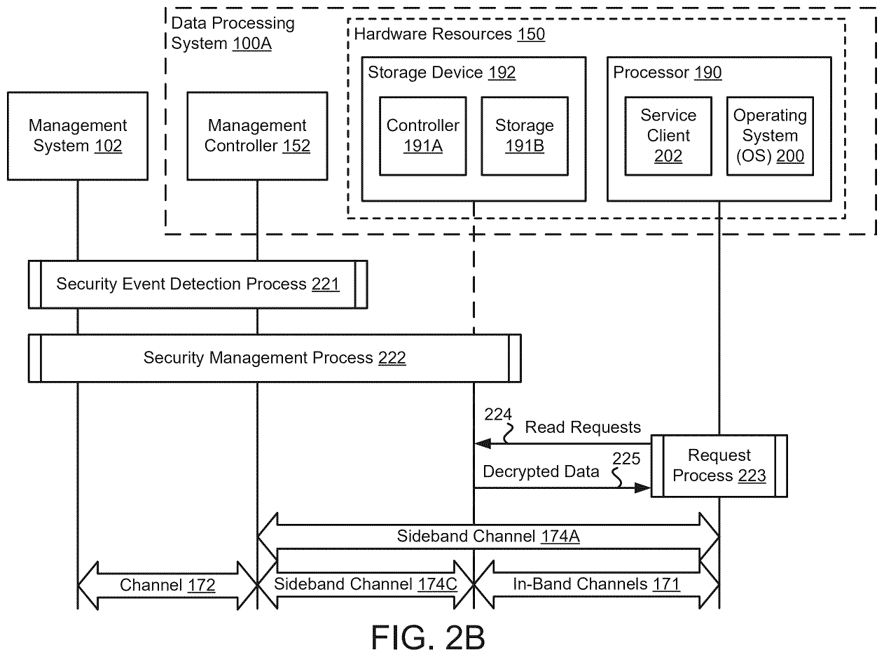

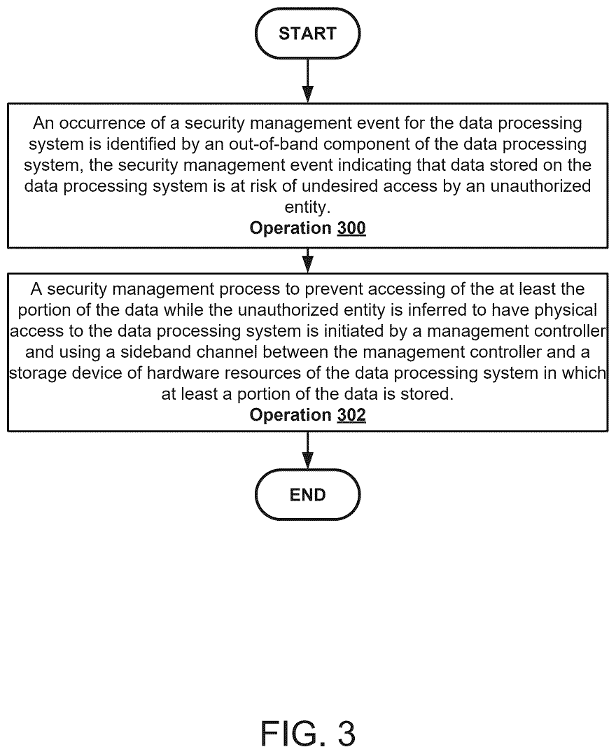

While providing their functionality, any of data processing systems 100, and/or management system 102 may provide all or a portion of the methods shown and discussed with regard to FIGS. 2A-3.

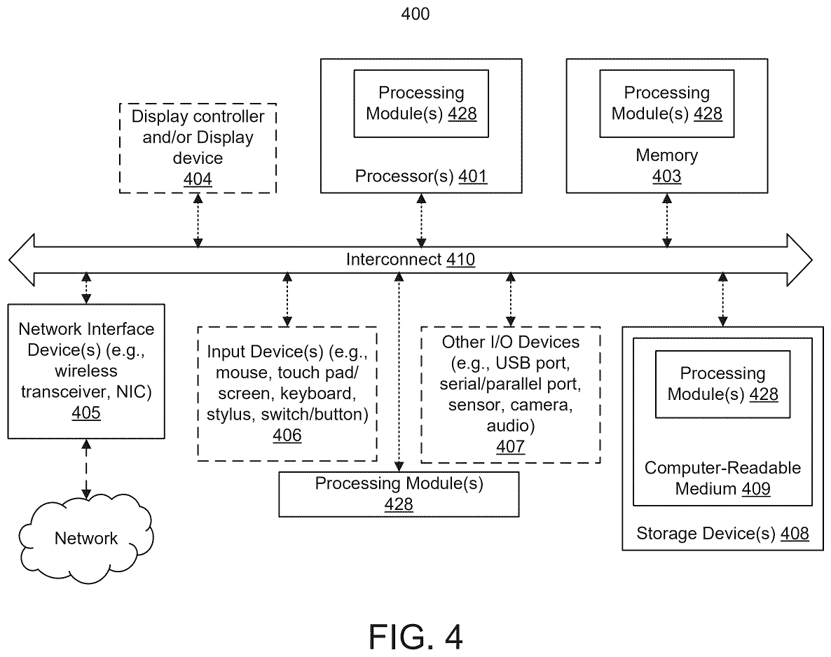

Communication system 104 may allow any of data processing systems 100, and/or management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system.

For additional details regarding computing devices, refer to FIG. 4 discussed further below.

Thus, as shown in FIG. 1A, a system in accordance with an embodiment may manage operation of a data processing system by detecting security events and attempting security management processes from there in an attempt to mitigate the negative impacts that may be caused by, for example, unauthorized access to data from the distributed system.

While illustrated in FIG. 1A with a limited number of specific components, a system may include additional, fewer, and/or different components without departing from embodiments disclosed herein.

Turning to FIG. 1B, a diagram illustrating a data processing system (e.g., 100A in FIG. 1A) in accordance with an embodiment is shown. As shown in FIG. 1B, data processing system 100A may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, (i) memory (e.g., non-volatile memory), (ii) a controller that may manage data operations (e.g., storage, retrieval, organization, etc.), and/or (iii) other physical components. The storage device may support storage protocols (e.g., non-volatile memory express) that may facilitate use of storage resources of the storage device.

For example, the storage may include a first storage device adapted to host an image of a startup management entity (e.g., basic input/output system (BIOS)), system configurations, and/or any other information. Additionally, the storage may include a second storage device that may include, but not be limited to, storage for information necessary to boot the data processing system, load an operating system for the data processing system, and/or perform any other processes.

The processor may host various management entities such as operating systems, drivers, network stacks, a service client, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, utilization of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150 of a host data processing system 100A). Management controller 152 may provide various management functionalities for data processing system 100A. For example, management controller 152 may monitor various ongoing processes performed by the in-band components, may manage power distribution, thermal management, and/or other functions of data processing system 100A.

To provide the management functionalities, management controller 152 may utilize data that may, at least temporarily be stored on storage resources hosted by management controller 152. For example, management controller may download an image of a new management entity (e.g., firmware, application, etc.) in response to a management request, store the image, and install the new management entity using at least the image on hardware resources 150.

Because an ability of management controller 152 to provide the management functionalities may be limited when the data exceeds storage capacity of storage resources hosted by the management controller, management controller 152 may utilize any number and/or types of storage devices hosted by hardware resources 150.

To do so, management controller 152 may be operably connected to various components via sideband channels 174 (in FIG. 1B, a limited number of sideband channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, management controller 152 may communicate information relevant to identifying a boot status of data processing system 100A, storing data to a boot partition of a storage device of hardware resources 150, restoring boot data hosted by a boot storage device, initiating a rebooting processing, and/or performing any other actions.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of management controller 152 and any entities hosted by management controller 152.

For example, storage devices of hardware resources 150 may not be operably connected to a processor (e.g., due to in-band channels between the processor and the storage devices not being functional during the booting process). Management controller 152 may communicate with the processor and the storage device via sideband channels 174. By doing so, management controller 152 may perform management functionalities (e.g., detecting security events indicative of a high-risk security threat to the system) or detecting a system hang during booting, obtaining data from a storage device, restoring boot data on the boot storage device, etc.) regardless of an operating state of hardware resources 150.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, which may be independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3B.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, and storage device 192. For example, to place a data processing system (e.g., 100A) in a desired operating state, data processing system 100A may perform a booting process to initialize hardware resources and facilitate operation of an operating system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, universal extensible firmware interface (UEFI), etc.), system configuration files, and/or any other information usable to boot data processing system 100A. Because boot storage device 191 may have a limited storage capacity, storage device 192 may be used to store additional information (e.g., other copies of boot data and/or files of other types of data).

Storage device 192 may include, for example, a second storage device such as a non-volatile memory express (NVMe) based solid-state drive. Storage device 192 may include a boot partition (193) that may be configured to store data usable to boot data processing system 100A (e.g., the latest stable copy of boot data, bootloader files, configuration files, etc.). Boot partition 193 may include an allocated section of storage device 192 that may, for example, be isolated from other memory sections of storage device 192.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

However, at least a portion of in-band channels 171 may not be functional and/or may have reduced functionality during booting of data processing system 100A and/or as a result of an undesired boot event. For example, in an event that storage device 192 and/or hardware components 195 are not initialized during booting, processor 190 may not be able to communicate with storage device 192 to obtain a copy of boot data (e.g., a backup copy, a recovery file, etc.) for use in rebooting and placing data processing system 100A in a desired operating state.

Thus, to improve a likelihood that data processing system 100A may be booted and placed in the desired operating state, management controller 152 may perform management functionalities using any number and/or type of sideband channels (e.g., 174). For example, management controller may obtain information (e.g., telemetry data, process results, boot times, etc.) regarding a boot status from processor 190 using sideband channel 174A, replace a copy of undesired boot data hosted by boot storage device 191 with a latest stable copy of boot data using sideband channel 174B, read and/or write boot data to boot partition 193 of storage device 192 using sideband channel 174C, and/or perform any other actions by communicating with components of hardware resources regardless of a boot status of data processing system 100A.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 152, 192, 190, 202, etc.), located towards the top of each figure. Lines descend from these shapes. Processes performed by the components of the system are illustrated using a second set of shapes (e.g., 211, 212, 213, etc.) superimposed over these lines. Interactions (e.g., communication, data transmissions, etc.) between the components of the system are illustrated using a third set of shapes (e.g., 214, 215, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur. Out-of-band and in-band communication channels (e.g., sideband channels) that operably connect various components of the system with one another are illustrated using a fourth set of shapes (e.g., 174A, 172, 171, etc.) that extend between the lines. The fourth set of shapes may include large double ended arrows that indicate use of a sideband channel between two of the components.

The processes and interactions are temporally ordered in an example order, with time increasing from the top to the bottom of each page. For example, the interaction labeled as 212 may occur prior to the process labeled as 213. However, it will be appreciated that the processes and interactions may be performed in different orders, any may be omitted, and other processes or interactions may be performed without departing from embodiments disclosed herein.

The lines descending from some of the first set of shapes (e.g., 102, 152, 192, 190, etc.) are drawn in dashing to indicate, for example, that the corresponding components may not be (i) operable, (ii) powered on, (iii) present in the system, and/or (iv) not participating in operation of the system for other reasons. (e.g., not being utilized by, for example, a management controller using an out-of-band communication channel). This dashing may alternate back to the original solid (e.g., non-dashed) characteristic of the descending lines and vice versa any number of times.

The change between the original solid and the dashing as the lines descend may be marked by diagonal, yet parallel with regard to one another, lines that cut the descending lines as they change. Such marked cuts along the descending lines are drawn to indicate, for example, moments of change where a processor (e.g., 190) may utilize respective in-band communication channels to (i) interact with various components of a (potentially compromised) data processing system, or (ii) cease interaction with any of the various components.

It will also be appreciated that utilization of out-of-band communication channels may be facilitated for security purposes. For example, and generally, a processor of the data processing system may perform functionalities for a booting process that include taking inventory of any and all operably connected devices. However, under a preventative assumption in which the data processing system may be assumed to be otherwise compromised. For example, if in a malicious entity's control, any number of security features and/or configurations of the system may be bypassed, deprecated, etc. Consequently, communications that may be intercepted and/or otherwise perverted via in-band channels during management of connected devices may instead be isolated when via sideband channels that prevent such interference.

Turning to FIG. 2A, a first interaction diagram in accordance with an embodiment is shown. The first interaction diagram may illustrate processes and interactions that may occur during management of a data processing system's (e.g., 100A's) operation during, for example, an identified risk of unauthorized access to the data processing system's data.

To manage the data processing system's operation, out-of-band components of data processing system 100A may perform security event detection process 211. These out-of-band components may do so by collaborating with one another via sideband communication channels (e.g., 172, 174A, 174C) to detect a security management event. For example, during security event detection process 211, (i) at least one indicator may be obtained, the at least one indicator being with regard to whether an unknown entity has physical access to the data processing system 100A, (ii) in an instance of the obtaining where the at least one indicator indicates that the unknown and/or unauthorized entity has the physical access to data processing system 100A, a confidence level may be obtained using the at least one indicator in a conclusion that the unknown and/or unauthorized entity has physical access to data processing system 100A, and (iii) in an instance of the obtaining where the confidence level exceeds a threshold level, the conclusion that the unknown and/or unauthorized entity has physical access to data processing system 100A and that the occurrence of the security management event has occurred may be made.

The at least one indicator may be at least one of any number of indicators such as, for example, (i) a user reported theft status (e.g., reported by an authorized user of the data processing system), (ii) ambient environment information (e.g., a generated image of the ambient environment while the data processing system is in use), (iii) location information (e.g., GPS coordinates of the data processing system's precise and/or approximate location), (iv) activity-based profiling data (e.g., patterns of activity based on use of the data processing system), and/or (v) any other type of indicator not to be limited by embodiments discussed herein.

It will be appreciated that the authorized user of data processing system 100A may be associated with specific instances of each of the above indicators. For example, the ambient environment information associated with the authorized user may include an image, captured by a camera of data processing system 100A. This image may include the authorized user in its foreground, and the authorized user's home, a favorite coffee shop, a nearby library, etc. in the background. For another example, the location information associated with the authorized user may include an area with a radius of a few miles and centered at some GPS coordinates positioned at where the authorized user's home and/or work may be. For another example, the activity-based profiling may include a first set of activity patterns that resulted from the consistent use of data processing system 100A by the authorized user.

Now assume that the authorized user is walking home late one night. Imagine that an unknown individual (e.g., person, entity, etc.), upon passing the authorized user, snatches a travel bag containing data processing system 100A away from the authorized user. Further assume that the unknown entity disappears around the corner, successfully getting away, but most likely not far away.

Therefore, based on this example scenario, the at least one indicator may be obtained based on the authorized user providing the user reported theft status (this being the at least one indicator in this scenario) to inform, for example, management system 102 of the theft of data processing system 100A (e.g., thereby indicating that the unknown entity may have physical access to the data processing system). This user reported theft status may be provided in a any number of way not to be limited by embodiments discussed herein (e.g., using another device to access a relevant account, calling an associated agency of management system 102, etc.)

The confidence level may then be obtained by using the at least one indicator as well as any other obtainable indicator of the indicators. For example, based on the at least one indicator being obtained, management controller 152 (being able to be independently powered) may utilize the sideband channels of data processing system 100A to obtain ambient environment information, location information, and/or activity-based profiling data.

Each indicator obtained may be scored via some scoring system to obtain the confidence level. For example, and for simplicity, assume a scoring system whose scores are between 0 and 1, with an indicator that is associated with the authorized user have a score of 0. Therefore we may have the user reported theft status score a 1, the ambient environment information (e.g., a generated image of the ambient environment while the data processing system is in use by the unknown entity) score a 1, (iii) the location information (e.g., GPS coordinates of the data processing system, and therefore, the unknown entity) score a 0, and (iv) activity-based profiling data (e.g., patterns of activity based on use of the data processing system by the unknown entity) score a 0.8.

It will be appreciated that although discussed above with regard to a specific example scoring system, The method of scoring and/or otherwise obtaining the confidence level may include any number of methods not to be limited by embodiments discussed herein.

Based on the example scores, the confidence level may be identified as a cumulative score of 3.8 out of 4

The confidence level may then be compared to a threshold level, the threshold level indicating, for example, a maximum confidence level possible while still assuming the authorized user is likely to have access to data processing system 100A. For example, the threshold level may be 0.5 out of 4. In this instance, the confidence level exceeds the threshold level, and a conclusion is made that the unknown entity has physical access to data processing system 100A and that the occurrence of the security management event has occurred.

It will be appreciated that, in this example, the security management event may be considered to have occurred if (i) the confidence level is higher than when last determined, and/or (ii) the confidence level crossed over the threshold level (from either direction) from when last determined. For additional information regarding how the security management event is identified as having last occurred, refer to FIG. 2B, discussed further below.

Based on this detection, the out-of-band components may perform security management process 212. During security management process 212, for example, (i) at least one security action may be identified based on the confidence level and a security policy, and (ii) the at least one security action may be performed to prevent the unknown entity from gaining access that could be detrimental to the authorized user should that access be gained.

For example, the security policy may include a set of rules/regulations for how security of data should be managed and to determine how much of the data should be managed in that way. These rules/regulations may be based on, for example, the confidence level discussed with regard to security event detection process 211.

Additionally, it will be appreciated that the security policy may specify for larger portions of the data to be subjected, in relation, to the confidence level's indication of the unauthorized physical access having occurred (e.g., based on a degree of confidence that unauthorized access of data processing system 100A had occurred).

For example, in the previously discussed scenario where the confidence level is obtained, the scoring system, on which the confidence level is based, (i) gave values closer to (or equal to) 1 when increasingly indicative of the unknown entity's physical access to data processing system 100A, and (ii) gave values closer to (or equal to) 0 when increasingly indicative of being associated with the authorized user.

With the previously obtained confidence level of 3.8 out of 4, the indicators may have been highly indicative of access that was not the authorized user's. With such confidence in there being a clear and/or present risk to the data stored on data processing system 100A, the security policy may include a rule that mandates for a majority, if not all, sensitive data (e.g., data that may be detrimental to the authorized user should it be leaked) to be subjected to the at least one security management action.

The at least one action may include any data management action that attempts to mitigate and/or prevent the unauthorized access from being detrimental to the authorized user and/or an associated communication network of data processing system 100A should that access be gained.

For example, the at least one action may include (i) deleting the sensitive data, (ii) hiding the sensitive data, (iii) moving the sensitive data, (iv) encrypting the sensitive data, (v) backing-up the sensitive data before doing any of the aforementioned, and/or (vi) facilitating any other process for mitigating detriment to the distributed system and/or of the authorized used.

Consider the previous example scenario with the confidence level of 3.8 out of 4. Based on this confidence, the security policy may specify having all system and security configurations, all financial records, all confidential employment information, all medical records, and flagged media files encrypted. The security policy may in some cases specify how as commands for the out-of-band components.

For example, to perform such encryption, one of the out-of-band components may generate cryptographic keys, a first portion to be stored with management system 102 and/or secured temporary storage of management controller 152, and a second portion to be used and deleted. For example, if generating symmetric keys, (i) a first key may be used with an encryption algorithm and the sensitive data to obtain encrypted versions of the sensitive data before being deleted, and (ii) a second key (a copy of the first key) may be stored with management system 102. Alternatively, if generating asymmetric key pairs, (i) a first key (a public key) may be used with an encryption algorithm and the sensitive data to obtain encrypted versions of the sensitive data before being deleted, and (ii) a second key (a private key generated with the public key) may be stored with management system 102.

Thus, based on out-of-band, automatic, communication signals provided by data processing system 100A in the distributed system of, for example, FIG. 1A, the automatic signals being based on respectively obtained deltas from indicators of authorized use of data processing system 100A, the sensitive data stored on data processing system 100A may be adequately protected (e.g., encrypted) such that the unauthorized access is less likely to pose the detriment, thereby making it more likely for the system to provide computer implemented services as expected and/or desired.

For example, the unknown entity may use the unauthorized access to provide commands to operating system (OS) 213 via service client 202 to have processor 190 perform actions as dictated by OS 200. For example, the unknown entity, in doing so, may initiate performance of request process 213.

During request process 213, as shown in FIGS. 2A-2B, processor 190 may facilitate interactions 214 and 215 with storage device 192 (controller 191A). Additionally, it will be appreciated that interactions 214 and 215 may be performed any number of times (e.g., the ability to loop).

At interaction 214, for example, read requests may be provided to controller 191A. These read requests may be requests for 191A to obtain specific data from storage 191B.

At interaction 215, the obtained specific data may be provided by controller 191A, however, due to the previously performed at least one action, only encrypted data may be returned based on the read requests. For example, such encrypted data may cause errors preventing service client 202 from displaying the specific data, thereby preventing the unknown entity and/or OS 200 from be able to use the data., and thus making in-band channel 171 useless for gleaning information about the authorized user and/or the distributed system via the sensitive data.

It will be appreciated that, although illustrated and discussed with regard to preventing disclosure of the sensitive data, the out-of-band components may, in some cases, be used similarly for facilitating a re-accessing of the sensitive data should the authorized user re-gain access to data processing system 100A (e.g., as discussed with regard to FIG. 2B below).

Turning to FIG. 2B, a second interaction diagram in accordance with an embodiment is shown. The second interaction diagram may illustrate processes and interactions that may occur during management of a data processing system's operation during, for example, an identification of authorized access of the data processing system.

To manage the data processing system's operation, out-of-band components of data processing system 100A may perform operations similarly to those operations discussed and shown with regard to FIG. 2A.

For example, assume the example scenario discussed with regard to FIG. 2A. To manage the data processing system's operation, the out-of-band components may collaborate with one another via the sideband communication channels (e.g., 172, 174A, 174C) to detect a second security management event as part of security event detection process 221. For example, during security event detection process 221, processes may occur exactly like security event detection 211, however, what we do with the end result of this process may be different.

Therefore, consider the following example extension for the previously discussed example scenario. Assume the unknown entity becomes frustrated when attempting to use the encrypted data from storage device 192, and the unknown entity decides to deliver data processing system 100A to the location at which the unknown entity had snatched it from the authorized user, thereby allowing the authorized user (to the authorized user's extreme surprise) to find it the next day. The authorized user may then bring it back to their own apartment where they proceed to power data processing system 100A on to gain authorized access.

In this example, management controller 152 may provide the at least one indicator based on the authorized user (i) relocating to the apartment already associated with the authorized user, and/or (ii) providing the user reported theft status to inform, for example, management system 102 of the repossession of data processing system 100A (e.g., thereby indicating that the authorized user may have physical access to the data processing system again).

The confidence level may then be obtained for this scenario. For example, assume that the at least one indicator is provided based on the authorized use occurring at the apartment.

The confidence level may then be obtained by using the at least one indicator as well as any other obtainable indicator of the indicators and scoring them using the previously discussed scoring system. These indicators may include, just as they had during security event detection process 211, ambient environment information, location information, and/or activity-based profiling data.

For example, and for simplicity, assume a scoring system whose scores are between 0 and 1, with an indicator that is associated with the authorized user have a score of 0. Therefore we may have the user reported theft status score a 0, the ambient environment information (e.g., a generated image of the ambient environment while the data processing system is in use by the authorized user) score a 0, (iii) the location information (e.g., GPS coordinates of the data processing system, and therefore, the authorized user) score a 0.2, and (iv) activity-based profiling data (e.g., patterns of activity based on use of the data processing system by the authorized user) score a 0.

It will be appreciated that although discussed above with regard to a specific example scoring system, The method of scoring and/or otherwise obtaining the confidence level may include any number of methods not to be limited by embodiments discussed herein.

Based on the example scores, the confidence level may be identified as a cumulative score of 0.2 out of 4.

The confidence level may then be compared to the previously discussed threshold level, the threshold level indicating, for example, a maximum confidence level possible while still assuming the authorized user is likely to have access to data processing system 100A. For example, the threshold level may be 0.5 out of 4. In this instance, the confidence level does not exceed the threshold level, and a conclusion may be made that the authorized user has physical access to data processing system 100A and that the occurrence of the security management event has occurred due to having crossed the threshold level from a previous confidence level (discussed previously with regard to FIG. 2A).

Based on this detection, the out-of-band components may perform security management process 222. During security management process 222, for example, (i) at least one security action may be identified based on the confidence level and the previously discussed security policy, and (ii) the at least one security action may be performed to prevent the unknown entity from gaining access that could be detrimental to the authorized user should that access be gained, in addition to, where it may be performed to re-establish the providing of the computer implemented services to the authorized user as desired and/or expected.

As previously discussed, for example, the security policy may include the set of rules/regulations for how security of data should be managed and to determine how much of the data should be managed in that way. These rules/regulations may be based on, for example, the confidence level discussed with regard to security event detection process 221.

For example, in the previously discussed scenario where the confidence level is obtained, the scoring system, on which the confidence level is based, (i) gave values closer to (or equal to) 1 when increasingly indicative of the unknown entity's physical access to data processing system 100A, and (ii) gave values closer to (or equal to) 0 when increasingly indicative of being associated with the authorized user.

With the previously obtained confidence level of 0.2 out of 4, the indicators may have been highly indicative of access that is belonging to the authorized user's. With such confidence in there being a clear indicator to the authorized access taking place, the security policy may include a rule that mandates for a majority, if not all, the sensitive data to be subjected to the at least one security management action.

The at least one action may include, in addition to what has been previously discussed, for example, (i) restoring sensitive data that was deleted, hidden, moved, (ii) decrypting the sensitive data that has been encrypted, and/or (iii) facilitating any other process for mitigating detriment to the distributed system and/or of the authorized used while also providing the computer implemented services as expected and/or desired by the authorized user.

Thus, based on out-of-band, automatic, communication signals provided by data processing system 100A in the distributed system of, for example, FIG. 1A, the automatic signals being based on respectively obtained deltas from indicators of authorized use of data processing system 100A, the sensitive data stored on data processing system 100A may be adequately protected (e.g., encrypted) such that the unauthorized access is less likely to pose the detriment, thereby making it more likely for the system to provide computer implemented services as expected and/or desired.

For example, the unknown entity may use the authorized access to provide commands to operating system (OS) 200 via service client 202 to have processor 190 perform actions as dictated by OS 200. For example, the authorized user, in doing so, may initiate performance of request process 223.

During request process 223, as shown in FIGS. 2A-2B, processor 190 may facilitate interactions 224 and 225 with storage device 192 (controller 191A). Additionally, it will be appreciated that interactions 224 and 225 may be performed any number of times (e.g., the ability to loop).

At interaction 224, for example, read requests may be provided to controller 191A. These read requests may be requests for 191A to obtain specific data from storage 191B.

At interaction 225, the obtained specific data may be provided by controller 191A, and due to the previously performed at least one action, any of the decrypted sensitive data may be returned based on the read requests.

Thus, using processes and interactions shown in FIGS. 2A-2B, a controller of an NVMe storage device and/or a management controller (both being out-of-band components of a data processing system) may perform a collaborative detection of security events that may indicate a risk of unauthorized access of the data processing system. Such detection may then be used to perform security management processes for potential occurrences of such risks of unauthorized access via, for example, management of the NVMe storage device's operation and/or the data processing system's operation. By doing so, a likelihood of data stored on the storage device being used in an unauthorized manner (such as without an authorized user's (to whom the data stored on the storage device is likely associated/belonging to) knowledge, consent, and/or autonomous regard) may be decreased.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage (e.g., manage operation of) a data processing system. FIG. 3 illustrates a method that may be performed by the components of the (distributed) system previously discussed with regard to FIGS. 1A-1C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by any of the components of the (distributed) system shown in FIGS. 1A-1C (e.g., management system 102, management controller 152, and/or the controller of storage device 192), and/or other components not to be limited by embodiments disclosed herein.

As previously discussed, an authorized user of a data processing system (e.g., 100A) may be displaced from the data processing system. If displaced, but then accessed while displaced, the accessing party may be an entity that is not authorized to use the data processing system (e.g., may be an unauthorized entity). Consequently, the data processing system may be at risk of having its data leaked through disclosure of said data to the public, the data being stored on a (e.g., NVMe) storage device of the data processing system, with little (if any) regard for the authorized user's privacy. Therefore, an out-of-band hardware infrastructure and a method that utilizes said infrastructure may be implemented for data security management purposes, as discussed below.

At operation 300, An occurrence of a security management event for the data processing system is identified by an out-of-band component of the data processing system, the security management event indicating that data stored on the data processing system is at risk of undesired access by an unauthorized entity. The occurrence may be identified by (i) obtaining at least one indicator regarding whether the unauthorized entity has physical access to the data processing system, and (ii) in an instance of the obtaining where the at least one indicator indicates that the unauthorized entity has the physical access to the data processing system, obtaining, using the at least one indicator, a confidence level in a conclusion that the unauthorized entity has physical access to the data processing system, and (iii) in an instance of the obtaining where the confidence level exceeds a threshold level, making the conclusion that the unauthorized entity has physical access to the data processing system and that the occurrence of the security management event has occurred.

To do so, the out-of-band hardware infrastructure may be utilized by a management controller (e.g., 152) as part of its functionality to operate independently from, and be distinct from, hardware resources (e.g., 150) of the data processing system.

Such functionality may be possible for the management controller due to the management controller being on a separate power domain from the hardware resources so that the management controller is operable while the hardware resources are inoperable. Therefore, the out-of-band component may be one selected from a group consisting of (i) the management controller, and, as it will be appreciated and discussed further below, (ii) a controller of the (e.g., NVMe) storage device. (e.g., 192).

The at least one indicator may include, for example, (i) a user reported theft status of the data processing system, (ii) information regarding an ambient environment of the data processing system, and/or (iii) location information of the data processing system. For example, (i) he information regarding the ambient environment may include, and/or be used for, initiating generation of an image depicting a portion of the ambient environment, the image being generated by the management controller of the data processing system and, in some cases, being used at the information regarding the ambient environment, (ii) the location information may include global positioning system (GPS) coordinates, and (iii) the user reported theft status may include one of two binary states (e.g., stolen or not stolen, as determined by the authorized user).

Once any single one of these indicators reflects a change of status and/or environment, such reflection may indicate that the data processing system is at risk of having an unauthorized entity gain physical access to the data processing system. Therefore, to acquire confidence regarding the risk to the data, several types of the indicators may be obtained similarly to the at least one indicator and used to obtain the confidence level. Therefore, using the user reported theft status, the information regarding the ambient environment, the location information, and a scoring system, the confidence level may be obtained, the scoring system quantifying the confidence level.

For example, assume that the user reported theft status can have a scoring of either 0 or 1 due to there only being two possible options for this status (e.g., stolen, or not stolen). Further assume that the information regarding the ambient environment and the location information can each have a scoring anywhere between 0 and 1. It will be appreciated however that these indicators may include additional types of the indicators not to be limited by embodiments discussed herein. Therefore, activity information of the data processing system (should in-band activity of the data processing system be used during this security event detection process), for example, may also be used with the abovementioned other types of indicators to obtain the confidence level. This activity information may be implemented as a user profiling that may be scored anywhere between 0 and 1.

So, for example, imagine a scenario in which the authorized user leaves the data processing system at a library in Houston, Texas one day, and doesn't think to check their travel bag for where the data processing system might be until the following morning when they realized it is not in their travel bag. Subsequently, once the authorized user had left the library, a nearby individual snatched up the data processing system in passing. This individual, let's assume, is someone who lives in a suburb 45 minutes away from the library such as in Katy, Texas, and heads to their home in Katy soon after snatching up the data processing system. As the individual takes the bus home, the data processing system's distance from the authorized user's apartment in the city (e.g., near the library) increases. Such increase in this distance may trigger, for example, a first security management event.

For example, the management controller may detect such an event due to location information such as GPS coordinates of the data processing system and GPS coordinates of the authorized user's apartment being quite different from one another, and becoming increasingly different as the bus continues to travel. Such a difference may award the location information a score of 1, 1 indicating a maximum difference between metrics of a same type such as the GPS coordinates, and 0 indicating that there is no significant difference.

Based on this score, it may be inferred that an unauthorized entity has the physical access to the data processing system. Next, the management controller and other out-of-band components may obtain additional types of the indicators to obtain the confidence level for this security management event. For example, the activity information may be obtained, however, the activity information may be lacking due to the unknown entity not having used the computer yet, not even opening it (e.g., assuming the data processing system is a laptop in this example). This inability to obtain and check valid activity data may be assigned a median score of 0.5. Similarly, the ambient environment cannot be checked easily. When, for example, the camera is covered, a snapshot of the environment is unable to be viewed by the data processing system. Therefore, we may also score the ambient environment information as 0.5 due to being inconclusive.

Finally, the user reported theft status of the data processing system is used to obtain a score of 0 due to the authorized user not noticing the data processing system was missing until the following day and self-reporting the theft then.

Thus, out of a possible score of 4, the confidence level for this first security management event may be a score of 2 out of 4. Additionally, assume that 2 out of 4 exceeds a threshold level corresponding to a security policy. For example, a score of 1 out of 4 or higher may indicate that the individual has the physical access to the data processing system, discussed further below.

At operation 302, A security management process to prevent accessing of at least a portion of the data while the unauthorized entity (e.g., the individual) is inferred to have physical access to the data processing system is initiated by a management controller and using a sideband channel between the management controller and a storage device of hardware resources of the data processing system in which the at least the portion of the data is stored. The security management process may be initiated by (i) identifying, based on the confidence level and the previously mentioned security policy, at least one security action; and (ii) performing the at least one security action to prevent the accessing of the at least the portion of the data while the unauthorized entity (e.g., the individual) is inferred to have physical access to the data processing system.

For example, the security policy may scale the at least the portion of the data based on the confidence level so that a higher confidence level results in a larger size of the at least the portion of the data.

For example, using the previously mentioned scenario, the confidence level of 2 out of 4 may correspond to a middle-level degree of encryption specified in the security policy. This may mean, for example, that a first sub-portion of data that is associated with a highest sensitivity/highest danger risk (if the first sub-portion is disclosed to the public). This first sub-portion may therefore be confirmed for encryption. A second sub-portion of data that is associated with a middle-tier sensitivity/danger risk (if the second sub-portion is disclosed to the public) may therefore be confirmed for encryption. In contrast, a third sub-portion of data that may be associated with a lowest-tier sensitivity/danger risk (if the third sub-portion is disclosed to the public) and may therefore not be confirmed for encryption.

For example, the first sub-portion may include security and/or network configuration data of a distributed system in which the data processing system is a part, and after the discussed first security management event detection and the first security management process are performed, this first sub-portion may be encrypted to avoid being accessed by unknown entities such at the individual.

The second sub-portion may include, for example, professional and/or financial data of the data processing system and based on the score of 2 out of 4, the second sub-portion may also be encrypted. The third sub-portion may include, for example, media files of the data processing system, and based on the score of 2 out of 4, the second sub-portion may not be encrypted.

It will be appreciated, however, that upon returning home, the individual opens and powers on the data processing system. Upon doing so, a second security management event may be detected due to the image representing the ambient environment being drastically different from the authorized user's usual environment.

This may again prompt the obtaining of more types of the indicators, resulting in the activity data also being able to contribute. The confidence level may then be identified via a score of 0 for the theft status, and a score of 1 for the ambient environment information, the location information, and the activity data. Therefore, the second security management event detection may result in a confidence level of 3 out of 4 that may correspond to a highest-level degree of encryption specified in the security policy. Such encryption may simply include encrypting the first, second, and third sub-portions of the data.

Furthermore, assume a scenario in which the individual becomes frustrated and gives up attempting to access the data processing system. Assume the individual return the data processing system, to where it had been snatched up. Upon this return to the library, a third security management event may be detected due to the location information changing drastically once more. However, this time the location information may indicate closer proximity to usual locations of the authorized user. Consequently, due to the currently encrypted state of the data, another confidence level may be obtained. For example, the authorized user may have changed the theft status by now, providing a scoring of 1. The location information may match, and therefore may be scored with a 0. The ambient environment, due to including not only the library, but also the individual, may be scored with a 0.3. The activity data for that day of return to the library, due to including, for example, only startup activity of the data processing system, may coincidentally match usual activity data of the authorized user, thereby having a score of 0. The resulting confidence level may therefore be 1.3 out of 4 that is associated with a lowest-tier sensitivity/danger risk. The following third security management process may therefore include, for example, decrypting the third and the second sub-portions of the data, but allowing the first sub-portion to remain encrypted until there is no risk of unauthorized access to the data processing system.

For additional details regarding, for example, different security management actions not to be limited by embodiments discussed herein, refer to the discussions of FIGS. 2A-2B.

The method may end following operation 302.

Thus, a method of managing operation of a data processing system in accordance with an embodiment is shown.

Any of the processes and/or components illustrated in and/or discussed with regard to FIGS. 1A-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
identifying, by an out-of-band component of the data processing system, an occurrence of a security management event for the data processing system, the security management event indicating that data stored on the data processing system is at risk of undesired access by an unauthorized entity; and
based on the identifying of the occurrence:
initiating, by a management controller and using a sideband channel between the management controller and a storage device of hardware resources of the data processing system in which at least a portion of the data is stored, a security management process to prevent accessing of the at least the portion of the data while the unauthorized entity is inferred to have physical access to the data processing system.

2. The method of claim 1, wherein the out-of-band component is one selected from a group consisting of the management controller and a controller of the storage device.

3. The method of claim 1, wherein identifying the occurrence of the security management event comprises:
obtaining at least one indicator regarding whether the unauthorized entity has physical access to the data processing system; and
in an instance of the obtaining where the at least one indicator indicates that the unauthorized entity has the physical access to the data processing system:
obtaining, using the at least one indicator, a confidence level in a conclusion that the unauthorized entity has physical access to the data processing system; and
in an instance of the obtaining where the confidence level exceeds a threshold level:
making the conclusion that the unauthorized entity has physical access to the data processing system and that the occurrence of the security management event has occurred.

4. The method of claim 3, wherein initiating the security management process comprises:
identifying, based on the confidence level and a security policy, at least one security action; and
performing the at least one security action to prevent the accessing of the at least the portion of the data while the unauthorized entity is inferred to have physical access to the data processing system.

5. The method of claim 4, wherein policy scales the at least the portion of the data based on the confidence level so that a higher confidence level results in a larger size of the at least the portion of the data.

6. The method of claim 3, wherein the at least one indicator comprises:
a user reported theft status of the data processing system.

7. The method of claim 6, wherein the at least one indicator further comprises:
information regarding an ambient environment to the data processing system.

8. The method of claim 7, wherein obtaining the at least one indicator comprises:
initiating generation, by the management controller of the data processing system, of an image depicting a portion of the ambient environment.

9. The method of claim 7, wherein the at least one indicator further comprises:
location information for the data processing system.

10. The method of claim 9, wherein the user reported theft status, the information regarding the ambient environment, and the location information are used to obtain the confidence level using a scoring system, the scoring system quantifying the confidence level.

11. The method of claim 1, wherein the management controller operates independently from and is distinct from the hardware resources.

12. The method of claim 11, wherein the management controller is on a separate power domain from the hardware resources so that the management controller is operable while the hardware resources are inoperable.

13. A non-transitory machine-readable medium having instructions stored therein, which when executed by a processor, cause the processor to perform operations for managing operation of a data processing system, the operations comprising:
identifying, by an out-of-band component of the data processing system, an occurrence of a security management event for the data processing system, the security management event indicating that data stored on the data processing system is at risk of undesired access by an unauthorized entity; and
based on the identifying of the occurrence:
initiating, by a management controller and using a sideband channel between the management controller and a storage device of hardware resources of the data processing system in which at least a portion of the data is stored, a security management process to prevent accessing of the at least the portion of the data while the unauthorized entity is inferred to have physical access to the data processing system.

14. The non-transitory machine-readable medium of claim 13, wherein identifying the occurrence of the security management event comprises:
obtaining at least one indicator regarding whether the unauthorized entity has physical access to the data processing system; and
in an instance of the obtaining where the at least one indicator indicates that the unauthorized entity has the physical access to the data processing system:
obtaining, using the at least one indicator, a confidence level in a conclusion that the unauthorized entity has physical access to the data processing system; and
in an instance of the obtaining where the confidence level exceeds a threshold level:
making the conclusion that the unauthorized entity has physical access to the data processing system and that the occurrence of the security management event has occurred.

15. The non-transitory machine-readable medium of claim 14, wherein initiating the security management process comprises:
identifying, based on the confidence level and a security policy, at least one security action; and
performing the at least one security action to prevent the accessing of the at least the portion of the data while the unauthorized entity is inferred to have physical access to the data processing system.

16. The non-transitory machine-readable medium of claim 15, wherein policy scales the at least the portion of the data based on the confidence level so that a higher confidence level results in a larger size of the at least the portion of the data.

17. A system, comprising:
a processor; and
a memory coupled to the processor to store instructions, which when executed by the processor, cause operations for managing operation of a data processing system to be performed, the operations comprising:
identifying, by an out-of-band component of the data processing system, an occurrence of a security management event for the data processing system, the security management event indicating that data stored on the data processing system is at risk of undesired access by an unauthorized entity; and
based on the identifying of the occurrence:
initiating, by a management controller and using a sideband channel between the management controller and a storage device of hardware resources of the data processing system in which at least a portion of the data is stored, a security management process to prevent accessing of the at least the portion of the data while the unauthorized entity is inferred to have physical access to the data processing system.

18. The system of claim 17, wherein identifying the occurrence of the security management event comprises:
obtaining at least one indicator regarding whether the unauthorized entity has physical access to the data processing system; and
in an instance of the obtaining where the at least one indicator indicates that the unauthorized entity has the physical access to the data processing system:
obtaining, using the at least one indicator, a confidence level in a conclusion that the unauthorized entity has physical access to the data processing system; and
in an instance of the obtaining where the confidence level exceeds a threshold level:
making the conclusion that the unauthorized entity has physical access to the data processing system and that the occurrence of the security management event has occurred.

19. The system of claim 18, wherein initiating the security management process comprises:
identifying, based on the confidence level and a security policy, at least one security action; and
performing the at least one security action to prevent the accessing of the at least the portion of the data while the unauthorized entity is inferred to have physical access to the data processing system.

20. The system of claim 19, wherein policy scales the at least the portion of the data based on the confidence level so that a higher confidence level results in a larger size of the at least the portion of the data.
